(19) United States
(12) Patent Application Publication
(10) Pub. No.: US 2008/0116365 A1
(43) Pub. Date: May 22, 2008

(54) Gamma ray spectral tool for improved accuracy and reproducibility in wellbore logging

(75) Inventor: Michael Flecker, Sugar Land, TX (US)

Correspondence Address: PAUL S MADAN;MADAN, MOSSMAN & SRIRAM, PC, 2603 AUGUSTA DRIVE, SUITE 700, HOUSTON, TX, 77057-5662, US

(73) Assignee: Core Laboratories LP

(21) Appl. No.: 11/600,536

(22) Filed: Nov. 16, 2006

(51) Int. Cl. G01V 5/12

(52) U.S. Cl. 250/261; 250/269.3

(57) ABSTRACT

An apparatus and method for logging information concerning the identity and/or condition of materials present within a wellbore is based on gamma ray spectroscopy. The apparatus includes a gamma ray source and at least one spectral gamma ray detector, with a controller capable of commanding or effecting digitization of the spectral data obtained by the detector. The data can be stored in a memory system and downloaded for analysis. The invention eliminates the problem of instrument “gain” and, because it generates spectral data, provides downhole qualitative and quantitative information beyond that of conventional non-spectral downhole imaging means and methods. Applications include, but are not limited to, reliably determining gravel pack integrity.

### BACKGROUND OF THE INVENTION

1. Field of the Invention

This invention relates to well logging tools and methods, and more particularly to a spectral gamma ray tool offering improved logging accuracy and reproducibility.

2. Background Art

A wide array of tools may be used for well logging. These tools, which can measure pressure, temperature, and a wide variety of other parameters, are typically lowered into the well at various points in drilling, completion and production operations to determine conditions downhole and/or the effect or result of various procedures. It is axiomatic in the art that, the better the quality and quantity of information that can be obtained about the downhole environment, the better the decisions that can be made with regard to ultimate production from the well.

One method that has been employed to obtain such information is based upon simple density measurements. For example, measuring the density of a annular gravel pack can help to detect voids, or “holidays” therein, and therefore indicate when remediation may be advisable. An apparatus to do this is described in U.S. Pat. No. 6,554,065. The tool described therein includes a gamma ray source, a detector, and memory capability. The gamma ray detector provides traditional counting techniques to establish relative densities of the gravel pack being logged. As such, it provides a somewhat limited, but useful, view of the overall condition of the gravel pack.

Other methods of characterizing aspects of the downhole environment also exist, but in general the known methods suffer from problems with reproducibility. It is common practice to perform a number of redundant loggings of a given zone of interest in a wellbore, such as a gravel pack, in order to enhance confidence in the results. This is necessary because of the great expense of remediation balanced against the possibility of poor or failed production. Unfortunately, many methods of logging wellbores encounter problems relating to calibration, and as such, reproducibility is often reduced to less than desirable levels.

Furthermore, there are a wide variety of materials that may be present in a downhole environment. These include, for example, water; hydrocarbons such as gas and oil; cements; casing materials; completion fluids; paraffins; drilling muds; sand; proppants; scale; combinations thereof; and the like. Some of these are desirable, others are undesirable, and still others may suffer from defects or voids. While a number of downhole logging tools have been designed to review gravel pack condition, very few address the presence, or absence, of such other materials in a way that allows the materials to be both quantified and qualified.

Accordingly, what is needed in the art is a method or means to enable a more complete and more reproducible understanding of the downhole environment, and of any or all of the materials encountered at a given location therein.

### SUMMARY OF THE INVENTION

A well logging apparatus that provides enhanced logging information coupled with improved reproducibility has been found. The apparatus comprises a gamma ray source; at least one spectral gamma ray detector that provides spectral gamma ray data for a plurality of energy spectra; and at least one controller, associated with at least one spectral gamma ray detector, that commands or effects digitization of the spectral gamma ray data; the apparatus being suitable for well logging.

In another aspect, the well logging apparatus may be employed in a method to characterize the downhole environment. This method comprises irradiating the interior of a wellbore containing at least one material with gamma rays emitted from a gamma ray source such that the gamma rays scatter. The gamma rays are then spectrally detected as spectral gamma ray data for a plurality of energy spectra, by at least one spectral gamma ray detector. The spectral gamma ray data is digitized, upon command or effect of the controller, and may then be stored in a memory system. Finally, the digitized spectral gamma ray data may be downloaded from the memory system to retrieve a plurality of energy spectra that characterize the material in the wellbore.

In a preferred embodiment of the invention, the gamma spectral ray data is both digitalized and stored in memory within the tool downhole, but other embodiments of the tool of the invention may be made. For example, if the tool of the invention is introduced downhole using an electric line, then the data may be transmitted to the surface and digitalized on site or at a remote location. In another embodiment, the data may be transmitted to a recording device at the surface and digitalized at a later time, again either on-site or at a remote location.

In yet another aspect there has been found a method for logging information about the integrity of a gravel pack in a wellbore. This method comprises, first, providing a downhole tool for use in a wellbore. The downhole tool comprises a gamma ray source and at least one spectral gamma ray detector. In this tool, the gamma ray source is adapted to emit gamma rays and the spectral gamma ray detector is adapted to detect gamma rays emitted by the gamma ray source and deflected to the gamma ray detector from a gravel pack. The detected gamma rays are converted to spectral gamma ray data, which is then digitized to form digitized spectral gamma ray data, by or upon command of at least one controller. The digitized data is then transferred to a memory system adapted to receive and store it. The downhole tool is located at a predetermined location relative to a gravel pack in a wellbore. The downhole tool's gamma ray source is incited to emit gamma rays; and the spectral gamma ray detectors to detect the gamma rays, which are then digitized and stored in a memory system, while the tool is moved in the wellbore proximate to the gravel pack by means of a conveying member. The memory system is then downloaded to retrieve the digitized spectral gamma ray data therefrom, and the digitized spectral gamma ray data provides a well log characterizing the gravel pack.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals and wherein:

FIG. 1 is a schematic diagram, showing a logging tool of the invention; and

FIG. 2 shows a deployment of a logging tool of the invention within a wellbore.

### DETAILED DESCRIPTION OF THE EMBODIMENTS

Described herein in general is an apparatus and a method for logging information particularly about materials present within a wellbore, based on gamma ray spectroscopy. For the purposes of the present invention, a wellbore is defined as the part of an oil and gas well that is the physical hole drilled through an underground formation and any man-made structures or apparatus that may be present therein.

The apparatus of the invention may be generally described as minimally comprising three different types of components, including a gamma ray source; at least one spectral gamma ray detector; and a controller associated with the spectral detector. While a number of variations of designs, makes and/or models of these components may be employed, and the means and method of their association varied, the components of the apparatus are suitable for use in well logging, which may imply certain parameters relating to design, structure, construction, and durability. The three minimal components generally work together to enable the effective logging of a wellbore such that a relatively detailed view of the downhole environment, including characterization and/or identification of materials present therein and/or of the integrity of such materials, may be obtained in the form of a spectral output. This spectral output is in the form of a plurality of energy spectra that provides those skilled in the art with a relatively accurate and reproducible view of the environment through which the apparatus transits.

In operation the logging apparatus defined herein includes, first, a gamma ray source. As used herein, “source” refers to a component, which is or includes a source of gamma radiation. It is important to recognize that this “source” is a component of an apparatus, and that, therefore, gamma ray emitters such as radioactive elements injected into a formation are automatically excluded from the definition of “source.” The gamma rays emitted from this source are scattered within the wellbore. The source may include any radioactive element producing gamma radiation and, in non-limiting embodiments, may be selected from radioactive isotopes of scandium, iridium, antimony, barium, cesium, combinations thereof, and the like. In certain non-limiting embodiments the isotope known as cesium-137 may be selected. While not technically required by the definition of “source,” it will be understood by those skilled in the art that, in order to qualify as a component of an apparatus, the gamma ray source will, in most cases, imply a housing of some kind for the radioactive element. As such, the housing may or may not also comprise one or more of the other components of the apparatus.

The second major component of the apparatus of the invention is the gamma ray spectral detector. While only one such detector is required, in particular and non-limiting embodiments there are at least two of these detectors and in some non-limiting embodiments there are exactly two of these detectors. In still other embodiments, three or more such detectors may be employed.

The spatial relationships between the spectral gamma ray detectors and the gamma ray source, and between the detectors themselves, is desirably, in one embodiment, selected such that gamma rays emitted from the source will travel through a desired proportion of the wellbore prior to detection by the spectral gamma ray detectors. This may help to ensure that the proportion or percentage of the wellbore being logged is that which is selected. Thus, in some non-limiting embodiments it may be desirable to space one or more spectral detectors immediately adjacent the gamma ray source, while in other non-limiting embodiments one or more spectral detectors may be spaced farther away from the gamma ray source, in order to increase the distance the gamma rays travel and thereby provide data representing a greater proportion of the wellbore.

In some cases it may be desirable to determine the spatial relationships based on, in part, the anticipated wellbore diameter. Also, various arrangements of the spectral gamma ray detectors may be employed to further customize the zone of interest to be characterized. For example, a number of spectral gamma ray detectors may be arranged in an array, such as a closed circular array, or an annular array. In the practice of the method of the invention, the location of the tool is preferably such that the radius of investigation is limited to the wellbore. This may be accomplished using the placement and geometry of the device used to position the tool. Any of these arrangements, and others that are known to those of ordinary skill in the art, shall be deemed to be within the scope of the many embodiments of the invention.

Suitable spectral gamma ray detectors include those manufactured by, for example, Halliburton Logging Services, Houston, Tex., under the tradename TRACERSCAN™; Atlanta Scientific; and Schlumberger Technology Corporation, Houston, Tex., which have heretofore been employed in prior art methods.

Such devices may, in certain non-limiting embodiments, use a sodium iodide crystal to capture gamma rays and emit pulses of light in response to those gamma rays. These pulses of light have an intensity that is proportional to the energy level of the gamma ray, measured in electron volts. The resulting light pulses then strike a photomultiplier tube, which in turn emits a voltage pulse that is proportional to the energy level of the original gamma ray. This voltage pulse is also dependent on the photomultiplier tube's supply voltage. Those skilled in the art will appreciate that a photomultiplier tube's gain tends to drift over time because of environmental factors, and will therefore understand that the use in the present invention of a gamma ray source having a known energy will enable periodic, appropriate adjustments of the supply voltage, if desired, to ensure adequate drift compensation.

The third type of component in the apparatus of the invention is a controller. In many non-limiting embodiments, one controller is associated with each spectral gamma ray detector, but in other embodiments, a single controller may be associated with more than one detector. The controller may be of any type known and useful in the art, and in certain non-limiting embodiments may include, for example, an embedded processor, a read only memory system, a random access memory system, and appropriate interface circuitry to allow it to receive the spectral gamma ray data from the spectral gamma ray detector(s), and then to transfer that data to a memory system for storage. Other embodiments of a controller may also serve this role of simple transmission and are deemed to be within the scope of the meaning of the word “controller.” For example, the data rate, the number of channels and the exact format of the data may vary, the only requirement herein being that the controller, whether having one part or many, serves to ensure that the signals received from the spectral gamma ray detector(s) are digitized. Such digitization may occur within the controller, or within the spectral gamma ray detector, or even within a unit specifically dedicated to such digitization. Regardless of the physical location in which digitization occurs, however, it is the controller's job to see that such occurs.

In certain non-limiting embodiments, the controller may also provide control signals back to the spectral gamma ray detector. A variety of types of signals may be generally provided, for example, control signals relating to calibration circuitry for the photomultiplier tube supply voltage.

In configuration, it may be desirable, in some non-limiting embodiments, to effectively “bundle” all three required components into a single tool suitable for downhole deployment. In other non-limiting embodiments, one or two of the required components may be combined in a single tool, and other component(s) may remain separate there from and/or be combined in a second tool. For example, the gamma ray source may be introduced into the wellbore as a part of a single tool including also at least one spectral gamma ray detector and a controller. Alternatively, the gamma ray source may be independent of the detector(s) and therefore, though still comprising part of the apparatus, not be present in a single tool with any or all of the other components. Additional components may also be included in any configuration.

For example, if the apparatus of the invention is configured to be carried via electric wireline, the power source to the controller and the detector(s) may be any traditional source located at the surface. Such may include typical grid electricity, generator electricity, or a combination thereof. However, if the apparatus is to be employed via slickline, (non-electrical) wireline, coiled tubing, or via a washpipe or a combination thereof, the spectral gamma ray detector(s) and controller(s) may include their own power source(s), e.g., interconnection with a battery or batteries of some type. Interconnection with a battery that goes downhole with at least the gamma ray source and the spectral gamma ray detector(s) assures that the apparatus need not be introduced via electrical wireline, which makes use of the invention in this particular embodiment desirably convenient and generally less expensive to use; however, a battery may alternatively be located at the surface, in which case deployment of at least the gamma ray source and the spectral gamma ray detector(s) via electric wireline would be necessary.

Where a battery is included, such will, in one non-limiting embodiment, provide power to all of the various components of the apparatus that require power. The battery or batteries are desirably sufficient to provide this power for at least about 8 hours, which may allow for appropriately redundant loggings of zones of likely interest. In some embodiments, special batteries may be used, such as 9-volt lithium or alkaline battery sticks. Lithium batteries may be especially useful in high temperature applications, and are, in some non-limiting embodiments, capable of operating at temperatures up to about 200° C. For lower temperature applications, alkaline batteries may be selected and are desirably capable of operating at temperatures up to about 80° C. In some non-limiting embodiments the batteries are desirably able to source about 10 to 20 watts for about 8 hours, and are also, for obvious practical reasons that will be easily understood by those skilled in the art, desirably diode- and overload-protected.

In some non-limiting embodiments the components may be interconnected such that the battery or batteries provide a 9 volt supply voltage to a central, single power supply. The power supply, in turn, may provide +5 volts to the controller, and +5±0.15 volts to each spectral gamma ray detector.

In some embodiments the power supply, whether surface-located and/or battery, may also supply electricity to a memory system. A memory system is an optional component of the apparatus, but is employed in many embodiments thereof. The memory system may be a separate component or it may be a part of another component such as a controller.

In certain non-limiting embodiments, the memory system stores the spectral gamma ray data received from the controller. Memory systems are replete in the art and, as such, lengthy discussion of their merits and capabilities herein is unnecessary. Such memory system may be located downhole, and comprise a part of a tool including or comprising the apparatus; or a memory system may be located at the surface, and receive the data via electric line during the logging process, or following retrieval of the spectral gamma ray detector(s) and/or controller(s) from the wellbore. Essentially any memory system component or components capable of storing the incoming data and from which the data can ultimately be downloaded in a desirably uncorrupted form may be employed.

Because memory storage capacity is obviously finite, those skilled in the art will appreciate that it may, in some non-limiting embodiments, be desirable to compress the spectral gamma ray data, generally after or concurrent with digitization, in order to ensure that the data does not overwhelm the storage space available in the memory system. Any conventional compression routine may be used, such as, for example, routines in which consecutive channel values that are equal to each other are stored as repeat strings, or if non-repeating elements of the same size (e.g., 4-bit elements or 8-bit elements) are encountered, the repeat values may instead be attached to the adjacent string of non-repeating elements.

Where compression is employed, a decompression routine may, in some non-limiting embodiments, also be needed, such that it can be used in the process of retrieving the data from the memory system. One example of such a routine may be found in the source code provided in connection with U.S. Pat. No. 5,608,214, which is incorporated herein by reference in its entirety, and which will be easily understood by those skilled in the art.

The method of the present invention, then, corresponds in many ways to the operation of the described apparatus. An apparatus, or “tool,” may be inserted into the wellbore and located as desired. Such location is, in some embodiments, determined based upon surface-acquired depth information, and may be in a place where production is ultimately desired. For example, such location may be where cement or casing has been placed, and/or where a gravel pack is located. The tool is moved, or “transited,” through the given section of wellbore, often for a desired number of trips to produce redundant sets of data for comparison. As the tool moves, the gamma ray source emits gamma rays at a known energy level, and these gamma rays are detected by the spectral gamma ray detector(s). The spectral gamma ray detector(s) both count the number of gamma rays and also measure their intensities, i.e., their energy levels. In doing so, the detector(s) transform the gamma rays into spectral gamma ray data, which is then digitized, in some embodiments by or under the command of the controller.

The digitized gamma rays may then be transferred, in either compressed or uncompressed form, to a memory system, from which they may be downloaded, and decompressed if necessary, as energy spectra that characterize the region through which the gamma rays traveled between the source and the detector(s). The final result is a view of the downhole environment that is both quantitative and qualitative, i.e., upon analysis the data can be interpreted by the skilled practitioner to provide the likely identification of a material or group of materials; the annular proportion of a material or group of materials; and the condition of that material or group of materials, i.e., whether there are in the material any voids, undesirably thicker or thinner areas, defects, etc. This information is, then, relatively detailed and surprisingly reproducible over successive trips of the well logging apparatus. These more accurate and reproducible results facilitate better and faster decisions relating to completion operations and the like, thereby saving both money and time.

The practice of the method of the invention offers several advantages over the conventional art which is practiced using a gross count detector. For example, feedback spectra may be used to maintain the gain of the detector thereby compensating for temperature differential effects upon signal amplification. For example, the feedback spectra can be evaluated in real time to maintain the energy to channel relationship. In another embodiment of the invention, this can also be accomplished during post processing by review of the histogram and re-correlating the energy to channel relationship after the data has been recorded.

Another advantage of the method of the invention over the prior art is by discriminating between the gamma count rate from the gamma source associated with the tool and any gamma radiation present from the background formation due to naturally occurring isotopes or from the presence of gamma radiotracers already present in the wellbore. By deconvolving the spectra, the radiation from the tool source may be ascertained and contributions to gross count from other sources ignored.

Still another advantage of the present invention is the ability to observe changes to the gamma spectra as the tool is placed into different environments downhole. The spectra can change as the tool passes through areas having different materials. Changes in the spectra as the materials in the radius of investigation vary can be observed when, for example, the spectra are displayed as a histogram. Changes in the shape of the gamma spectra histogram can be used to predict conditions downhole.

In particular, the apparatus and method described herein are useful for examination of completed wellbores. In one particularly useful application, the apparatus and/or method may be employed to determine the integrity of a downhole gravel pack. In another application, the apparatus and/or method may be used to determine the integrity of a cement, a wellbore casing made of metal or an alloy, or some other non-natural feature. In still other applications, such may be useful in discerning and/or identifying other materials introduced into and/or inherently present within a wellbore, such as liquids, gases, and solids. Thus, the variety of materials that may be characterized and recognized by the apparatus and method of the invention include cements; casing metals and alloys; water; gas and oil hydrocarbons; solid paraffins; completion fluids; drilling muds; sand; proppants; scale; combinations thereof; and the like. Those skilled in the art will be aware of other potential applications of the invention.

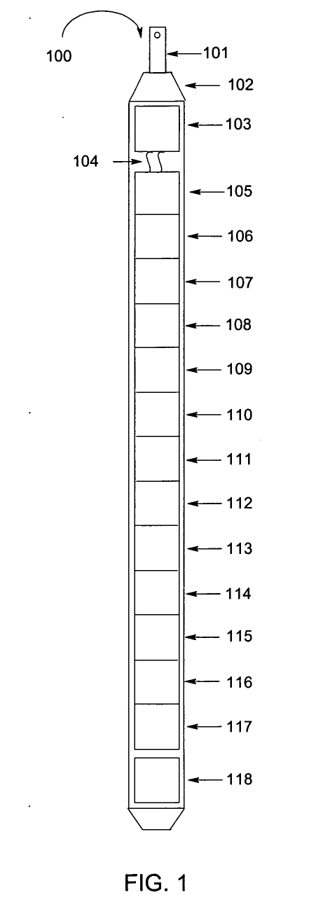

In FIG. 1, a logging tool of the invention (100) is shown. As shown, the tool has three sub-assemblies. The first sub-assembly is a battery (103) which may consist of one or more electrical energy storage devices. The second sub-assembly consists of a tungsten shield (117), a detector array and associated electronics (105-117). The tungsten shield serves to protect the detector array from direct exposure from the gamma source (118) which is also the third sub-assembly.

Next to the tungsten shield is the first detector. The first detector includes a first scintillation crystal (116). Gamma radiation from the source may be scattered such that some of the gamma rays enter into the first scintillation crystal where it produces a photon which in turn passes into a first photomultiplier tube (115) to produce a signal which is in turn passed into a first signal amplifier (114).

A second identical detector is present on the tool. The second detector includes a second scintillation crystal (113), a second photomultiplier tube (112), and a second signal amplifier (111). The second detector in the embodiment illustrated functions identically to the first detector, but in an alternative embodiment, the second detector may be of a different type or include additional components.

Power at appropriate amperage and voltage is supplied to the detectors by the amplifier power supply (110) and the photomultiplier tube power supply (109). The signals from the first detector are introduced into a first pulse height analyzer (108) which converts the signal to a digital value representing the intensity and the energy level of the gamma radiation which entered the first detector. A processor (106) generates a record that includes the intensity and the energy level of the gamma radiation, the detector from which it came and the time at which is was received. The record is stored in the memory (105). The power for the tool is taken, in this embodiment, from the battery (103) which is transferred to the detector array and other electronics using the cables shown (104) as well as other cables and conductors (not shown).

In the embodiment shown, the sub-assemblies are within a single tool casing (102). In an alternative embodiment, the sub-assemblies are contained in separated cases, which may couple either directly or indirectly together. The tool may be attached, at the connection point (100), to an electric line or slickline. In an alternative embodiment, the tool may be configured such that it can be attached to the inside of a pipe or other tubular apparatus or attached directly to the end of a wash tube or similar apparatus.

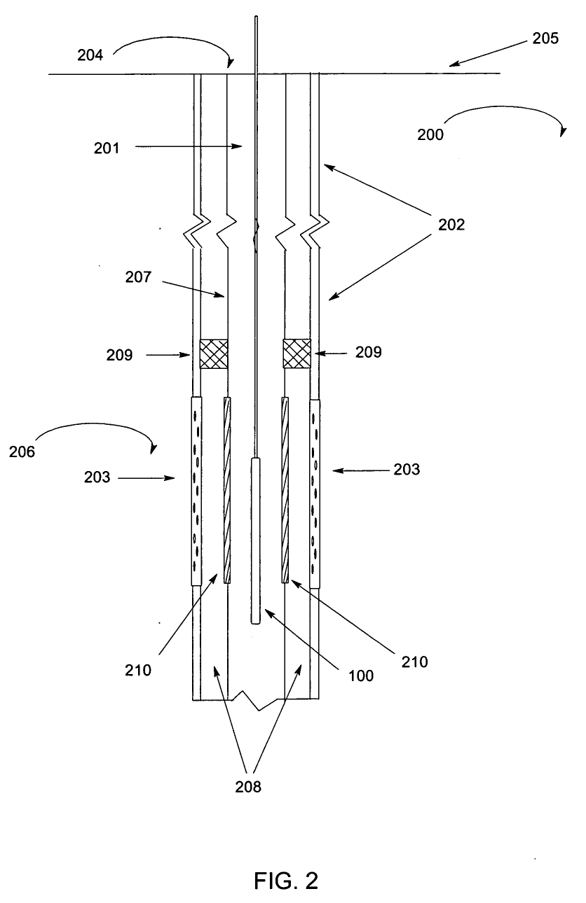

In FIG. 2, a tool of the invention (100) is shown in use in a wellbore (204) drilled through a subterranean formation (200). The tool is suspended from a wireline (201) within a casing (202) and inside production tubing (207) at the depth of a producing strata of the formation (206). The tool is adjacent and slightly below a perforated section of the casing (203) and a section of the production tubing having slots (210). Hydrocarbons enter the annulus between the casing and the production tubing through the perforations and then enter the production tubing through the slots. Also shown is a packer (209) which acts to plug the annulus between the casing and the production tubing to direct the flow of the hydrocarbons into the production tubing. Typically, the space within the annulus between the casing and the production tubing is filled with a media (not shown), most often gravel, to prevent solids from entering the wellbore and to reduce the velocity of fluids entering the wellbore. When the media is gravel, this is known as a gravel pack. The surface (205) is shown and may be a land surface or the bottom of a lake or ocean.

The foregoing description is directed to particular embodiments of the present invention for the purpose of illustration and explanation. It will be apparent, however, to those skilled in the art that many modifications and changes to the embodiments set forth above are possible without departing from the scope of the claims appended hereto. It is intended that the following claims be interpreted to include all such modifications and changes.

We claim:

1. A well logging apparatus, comprising
a gamma ray source;
at least one spectral gamma ray detector that detects the gamma radiation emitted by the gamma ray source and provides spectral gamma ray data for a plurality of energy spectra; and
at least one controller coupled to the at least one spectral gamma ray detector and commanding or effecting the digitization of the spectral gamma ray data;
the apparatus being suitable for well logging wherein a majority of gamma rays emitted by the gamma ray source are scattered within a wellbore.

2. The apparatus of claim 1 wherein the gamma ray source comprises a radioactive form of an isotope selected from the group consisting of barium-133, scandium-46, iridium-192, antimony-124, cesium-137, and combinations thereof.

3. The apparatus of claim 2 wherein the gamma ray source is cesium-137.

4. The apparatus of claim 1 wherein there are a plurality of spectral gamma ray detectors.

5. The apparatus of claim 4 wherein the plurality of spectral gamma ray detectors are independently located relative to the gamma ray source.

6. The apparatus of claim 1 further comprising at least one memory system coupled to the controller, the memory system receiving and storing the digitized spectral gamma ray data.

7. The apparatus of claim 6 wherein the controller compresses the digitized spectral gamma ray data to provide compressed digitized spectral gamma ray data to the memory system

8. A method for characterizing a material in a wellbore comprising
irradiating the interior of a wellbore, containing one or more materials, with gamma rays emitted from a gamma ray source such that the gamma rays scatter;
spectrally detecting, by at least one spectral gamma ray detector, the scattered spectral gamma rays as spectral gamma ray data for a plurality of energy spectra;
digitizing the spectral gamma ray data by or upon command of a controller associated with the at least one spectral gamma ray detector;
transmitting the digitized spectral gamma ray data to a memory system associated with the controller for storage; and
downloading the digitized spectral gamma ray data from the memory system to retrieve a plurality of energy spectra that characterize the material or materials.

9. The method of claim 8 wherein the gamma rays are emitted by a gamma ray source comprising a radioactive form of an isotope selected from the group consisting of barium-133, scandium-46, iridium-192, antimony-124, cesium-137, and combinations thereof.

10. The method of claim 8 wherein the gamma ray source is cesium-137.

11. The method of claim 8 wherein a plurality of spectral gamma ray detectors are independently located relative to the gamma ray source.

12. The method of claim 8 wherein the material in the wellbore being characterized comprises a non-natural feature.

13. The method of claim 12 wherein the non-natural feature is selected from the group consisting of a cement; a metal or alloy casing; a gravel pack; a completion fluid; a drilling mud; a proppant; a scale; and combinations thereof.

14. The method of claim 13 wherein the non-natural feature is a gravel pack.

15. The method of claim 8 wherein the plurality of energy spectra are displayed as a histogram and the shape of the histogram is used to make determinations regarding downhole conditions.

16. A method for logging and interpreting information about the integrity of a gravel pack in a wellbore, comprising
providing a downhole tool for use in a wellbore, wherein the downhole tool comprises a gamma ray source and at least one spectral gamma ray detector;
and wherein the gamma ray source is adapted to emit gamma rays, and the spectral gamma ray detector is adapted to detect gamma rays emitted from the gamma ray source and deflected to the gamma ray detectors from at least one material within the wellbore; and wherein the downhole tool further comprises a controller adapted to command or effect digitization of the spectral gamma ray data and to transfer the digitized spectral gamma ray data to a memory system for storage;
locating the downhole tool within a zone of interest in a wellbore;
inciting the downhole tool's gamma ray source to emit gamma rays, and the at least one spectral gamma ray detector to detect the gamma rays, and the controller to command or effect digitization of the spectral gamma ray data and to transfer the digitized data to the memory system, while moving the tool approximately through the zone of interest by means of a conveying member; and
downloading the memory system to retrieve the digitized spectral gamma ray data therefrom to provide a log characterizing the gravel pack.

17. The method of claim 16 wherein the gamma rays are emitted by a gamma ray source comprising a radioactive from of an isotope selected from the group consisting of barium-133, scandium-46, iridium-192, antimony-124, cesium-137, and combinations thereof.

18. The method of claim 17 wherein the gamma ray source is cesium-137.

19. The method of claim 16 wherein a plurality of spectral gamma ray detectors are independently located relative to the gamma ray source.

20. The method of claim 16 wherein the digitized spectral gamma ray data is compressed by the controller prior to transfer to the memory system.
